(19) United States
(12) Patent Application Publication
(10) Pub. No.: US 2023/0017127 A1
(43) Pub. Date: Jan. 19, 2023

(54) EXTRACT-TRANSFORM-LOAD (E-T-L) PROCESS USING STATIC RUNTIME WITH DYNAMIC WORK ORDERS

(71) Applicant: SAP SE, Walldorf (DE)

(72) Inventors: Tobias KARPSTEIN, Eschelbronn (DE); Daniel BOS, Beijing (CN); Xiaoliang WANG, Beijing (CN)

(21) Appl. No.: 17/377,688

(22) Filed: Jul. 16, 2021

(51) Int. Cl. G06F 16/25; G06F 9/48

(52) U.S. Cl. CPC G06F 16/254; G06F 9/4881

(57) ABSTRACT

Disclosed herein are system, method, and computer program product embodiments for implementing static runtime with dynamic work orders. An embodiment operates by generating, by a controller, a runtime instance based on a runtime template and assigning, by the controller, a work order to the runtime instance. The work order is generated based on an Extract-Transform-Load (E-T-L) process. The embodiment further operates by executing, by the controller, the work order on the runtime instance and updating, by the controller, the work order in a storage.

### BACKGROUND

Extract-Transform-Load (E-T-L) process can include reading data from a source system, transforming the data from a first representation to a second representation, and then loading the transformed data in a target system. The E-T-L process can use a static runtime for every object to be transferred. Using the static runtimes can lead to circumstances where the static runtimes are periodically spun up and down, which is costly and introduces unwanted latency. Alternatively, the static runtime can be continuously running, which occupies computational resources although not fully utilizing the resources.

### BRIEF DESCRIPTION OF THE DRAWINGS

The accompanying drawings are incorporated herein and form a part of the specification.

FIG. 1 is a block diagram of an exemplary system for implementing static runtime with dynamic work orders, according to some embodiments.

FIG. 2 is a block diagram of an exemplary E-T-L system, according to some embodiments.

FIG. 3 is a block diagram of feedback loops in an exemplary E-T-L system, according to some embodiments,

FIG. 4 is a flowchart illustrating example operations of an E-T-L system, according to some embodiments.

FIG. 5 is example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing dynamic work orders with static runtime.

Some embodiments of this disclosure are related to generating one or more runtime instances from a runtime template, generating work orders to be executed on the runtime instance(s), and executing the work orders on the runtime instance(s). In some embodiments, the executed work orders are tracked and analyzed. The analysis information of the work orders are further used for updating the work orders. By using work orders and runtime instances generated from runtime template(s), the embodiments of this disclosure can efficiently use the computational resources and can reduce the cost of ownership (TCO) of the service overall. Additionally, the embodiments of this disclosure can efficiently react to priority change or any other changes in processes by simply injecting more work orders of one object over another. Although some examples of this disclosure are discussed with respect to an Extract-Transform-Load (E-T-L) process, the embodiments of this disclosure are not limited to these examples and the static runtime with dynamic work orders can be applied to other processes.

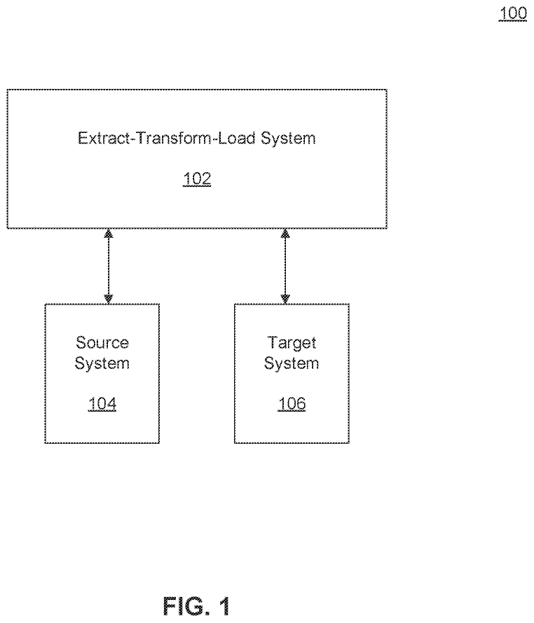

FIG. 1 is a block diagram of an exemplary system 100 for implementing static runtime with dynamic work orders, according to some embodiments.

According to some embodiments, system 100 can include E-T-L system 102, source system 104, and target system 106. E-T-L system 102 can be configured to extract (e.g., read, copy, etc.) data from source system 104. E-T-L system 102 can transform the extracted data from a first format to a second format. In some examples, E-T-L system 102 can transform the extracted data according to a business requirement, for data quality reasons, according to target system 104's requirement, and the like. After transforming the data, E-T-L system 102 can load (e.g., copy, store, write, etc.) the transformed data in to target system 104.

Although one source system 104 and one target system 106 are illustrated in FIG. 1, the embodiments of this disclosure can include any number of source systems and target systems. Additionally, E-T-L system 102 can support different source systems 104 and/or target systems 106. For example, source system 104 can include, but is not limited to, one or more databases, one or more object stores, one or more file systems, one or more message brokers, and the like. Also, target system 104 can include, hut is not limited to, one or more databases, one or more object stores, one or more file systems, one or more message brokers, and the like. E-T-L system 102 can also support a variety of transformation operations. For example, E-T-L system 102 can support predefined type conversion, scripting, data quality and glancing, and the like. The embodiments of this disclosure are not limited to these examples, and system 102 can support other operations and system 100 can include other source and target systems.

According to some embodiments, operating E-T-L system 102 can include achieving a high data throughput while occupying as little computational resources as possible. For example, minimal resource consumption (e.g., lowering a total cost of ownership (TCO)) is important if the process of E-T-L system 102 is offered as a cloud service. According to some embodiments, E-T-L system 102 is configured to minimize the TCO (e.g., the computation resources of system 100) by, for example, generating runtime instances from a runtime template, generating work orders to be executed on the runtime instances, and executing the work orders on the runtime instances.

In present systems, an E-T-L process has a static runtime for every object that is to be transferred. For example, a code is generated to process a specific table from a source system (including some transformation logic) into a target system. The start-up of such a static runtime, especially involving multiple systems, can be quite costly from a resource as well as time perspective. Depending on the capabilities of the source and target systems, the static runtime (e.g., the code for the static runtime) can reside locally on the E-T-L systems reaching the source and target systems using some standard libraries (e.g., JDBC, ODBC, REST). Additionally, or alternatively, the static runtime can be generated into the source or target system (e.g., database procedures or application specific code).

In present systems, the E-T-L process can transfer the data from the source system to the target system in two phases—an Initial Load (where the initial state of the source data in the source system is transferred) and a Delta Load (where changes in the source data are transferred). The Initial Load can have a definite finish point (once all initial data is transferred) and for the entire duration of the transfer, the data is readily available in the source system. Therefore, the E-T-L process can run at a stable resource utilization that can be calculated in advance. The Delta Load can typically run indefinite (e.g., while there is a business need for the data). The amount of data that is to be transferred can fluctuate, depending on how the source data changes. Therefore, it is generally difficult (or not possible) to pre-determine how much resources are needed to be allocated to the E-T-L process.

In present systems, the starting and stopping processes to execute the runtime (e.g., the generated code) can be quite expensive—both from a resource as well as time perspective. For example, during the Delta Load phase, the E-T-L system is to make a trade-off between resource usage and performance. The present E-T-L systems may periodically spin up and down the processes that introduces latency or may let the processes run continuously that results in occupying computational resources although not fully utilizing them.

In contrast to the present systems, E-T-L system 102 can be configured to use a static runtime as a template runtime with dynamic work orders. For example, E-T-L system 102 can be configured to use the template runtime for determining, for example, which table(s) from which source system(s) are read, processed, and written to which target system(s). An object (e.g., a work order) can be dynamically injected into the static runtime. According to some embodiments, E-T-L system 102 can have as many static runtimes continuously running as needed but fully or substantially fully occupy them. E-T-L system 102 can switch the context between the static runtimes on a very high frequency. According to some embodiments, E-T-L system 102 can be configured to separate the E-T-L processes into a common static runtime from which runtime instances) can be generated/started and into dynamic data (e.g., dynamic metadata) that can describe the varying part between multiple E-T-L processes in the form of work order(s).

According to some embodiments, each work order can describe a relatively small amount of work that is to be done for a specific E-T-L process. In some examples, a work order can include metadata (e.g., the dynamic metadata) such as, but not limited to, source system data, source object data, transformation data, target system data, target object data, and the like. The source system data can include data and information (such as, but not limited to, connection information) associated with source system 104. The source object data can include data and information (such as, but not limited to, filter and projections) associated with an object in source system 104 that is to be transformed and transferred by the specific E-T-L process of E-T-L system 102. The transformation data can include data and information associated with the transformation to be performed by the specific E-T-L process of E-T-L system 102. Target system data can include data and information (such as, but not limited to, connection information) associated with target system 106. The target object data can include data and information associated with an object in target system 106 that can include the transformed and transferred target object.

According to some embodiments, E-T-L system 102 can dynamically generate the work orders based on changes that E-T-L system 102 can detect in the source system and/or the target system, Additionally, or alternatively, E-T-L system 102 can dynamically generate the work orders based on requests from users (e.g., customers). In one example, E-T-L system 102 can periodically check which logs of source system 104 include records (e.g., new records) and which logs do not include any records. E-T-L system 102 can dynamically generate the work orders based on the logs that have records. E-T-L system 102 can dynamically inject the generated work orders to the runtime instances to execute the work orders. According to some embodiments, E-T-L system 102 can perform the static runtime with dynamic work orders operations with Delta Load operation.

According to some embodiments, E-T-L system 102 can be configured to use a small number of static runtime instances for performing the E-T-L processes. E-T-L system 102 can be configured to do so by dynamically generating and using the work orders and executing the work orders on the small number of the static runtime instances.

According to some embodiments, a work order can include information needed by E-TI system 102 to perform an E-T-L process. Therefore, E-T-L system 102 can execute the work order using any of the static runtime instances. E-T-L system 102 can determine which existing runtime instance to use, and E-T-L system 102 can execute (e.g., spin up or down) a number of runtime instances based on various metrics, such as, but not limited to the number of active E-T-L processes.

According to some embodiments, E-T-L system 102 can be configured to run in a cluster context serving multiple users (e.g., customers) at the same time or substantially the same time, as user specific information (e.g., customer specific information) can be contained in the work orders, and not in the runtime. Therefore, E-T-L system 102 can efficiently use the computational resources and can reduce the TCO of the service overall.

Using work orders can also have additional benefits. For example, E-T-L system 102 can efficiently react to priority or any other changes in the E-T-L processes by simply, injecting more work orders of one object over another. Therefore, E-T-L system 102 can dynamically react very fast to change-rate changes on source system 104.

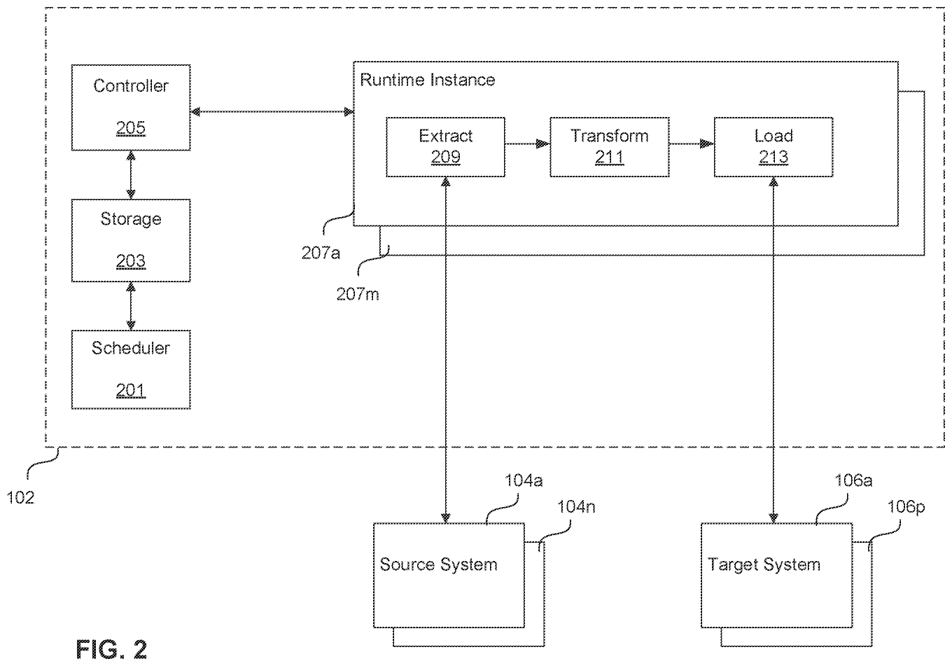

FIG. 2 is a block diagram of an exemplary E-T-L system 102, according to some embodiments. E-T-L system 102 can include scheduler 201, storage 203, controller 205, and runtime instances 207a-207m. According to some embodiments, E-T-L system 102 can be coupled to one or more source systems 104a-104n and one or more target systems 106a-106p. The structural and functional aspects of controller 205, storage 203, and scheduler 201 may wholly or partially exist in the same or different ones of controller 205, storage 203, and scheduler 201.

According to some embodiments, scheduler 201 can be configured to determine an E-T-L process and generate one or more work orders based on the E-T-L process. For example, scheduler 201 can be configured to break up the E-T-L process (e.g., an E-T-L job) into one or more work orders. An E-T-L process can include, but it not limited to, transferring data from a first object in source system 104a to a second object in target system 106a with some optional transformation. In addition to, or alternative to, the E-T-L process, scheduler 201 can be configured to generate one or more work orders for other processes. As discussed above, a work order can include dynamic data (e.g., dynamic metadata) to achieve a bound amount of work towards the over E-T-L process.

According to some embodiments, storage 203 can store the work orders. In some examples, storage 203 can include any data storage/repository device, such as, but not limited to, in-memory, a queue, a buffer, a database, and the like. For example, storage 203 can store the generated one or more work orders in storage 203 to be used by controller 205.

According to some embodiments, controller 205 can be configured to read (e.g., pull) the work order(s) from storage 203 for executing the work order(s). In some examples, controllers 205 can be configured to generate one or more runtime instances 207a-207m from a runtime template and based on the read work order(s). In a non-limiting example, controller 205 can generate one or more runtime instances 207a-207m based on a work order type associated with the read work order. However, controller 205 can generate one or more runtime instances 207a-207m based on other information associated with the read work order. Controller 205 can further assign the read work order to a runtime instance (e.g., runtime instance 207a). Controller 205 can further execute the work order on runtime instance 207a, Executing the work order on runtime instance 207a can include updating runtime instance 207a based on the information associated with the read work order and then executing the updated runtime instance 207a. Executing the work order on runtime instance 207a can include extracting data from source system 104a, transforming the extracted data, and loading the transformed data to target system 106a using the runtime instance 207a and the read work order.

In some examples, controller 205 can be configured to start or stop runtime instances 207a-207m based on one or more parameters to balance performance, computational resource usage, and/or costs.

According to some embodiments, controller 205 can be configured to track and monitor the status of the read work order that is executed on runtime instance 207a. Controller 205 can be configured to update the status of the work order in storage 203. For example, depending on the execution of the work order on runtime instance 207a, some data associated with the work order can change. Controller 205 can monitor these changes and update the work order in storage 203. Scheduler 201 can access and read the changes and/or the updated work order. Additionally, or alternatively, scheduler 201 can generate additional work order(s) based on the changes and/or the update work order.

According to some embodiments, each of runtime instances 207a-207m can include common logic and processes associated with an E-T-L process. Each of runtime instances 207 can include extract operation 209, transform operation 211, and load operation 213. Although runtime instance 207 is discussed with respect to extract operation 209, transform operation 211, and load operation 213, the embodiments of this disclosure are not limited to these examples and runtime instances 207 can be applied to other processes.

As discussed above, runtime instances 207a-207m can be generated by controller 205 from a runtime template and based on the work orders in storage 203. The runtime template can describe and define the composition of a runtime instance (e.g., the extract, transform, and load steps or other processes). In some examples, from one runtime template, multiple runtime instances can be generated and/or started. For example, runtime instances 207a-207m can be generated from one runtime template. However, in some embodiments, runtime instances 207a-207m can be generated from more than one runtime template.

In some examples, each runtime instance 207 is associated with a corresponding work order read by controller 205. In other words, controller 205 can generate one runtime instance for each work order. Additionally, or alternatively, controller 205 can generate one runtime instance for two or more (such as, but not limited to, hundreds or thousands of) work orders.

Based on the work order that is read by controller 205 and is assigned to and executed on runtime instance 207a, extract operation 209 can connect to a corresponding source system 104a to extract an object specified by the read work order. Transform operation 211 of runtime instance 207a can perform the optional transformation specified by the read work order. Load operation 213 can load (e.g., write, store, and the like) the transformed object in a target object in target system 106a as specified in the read work order.

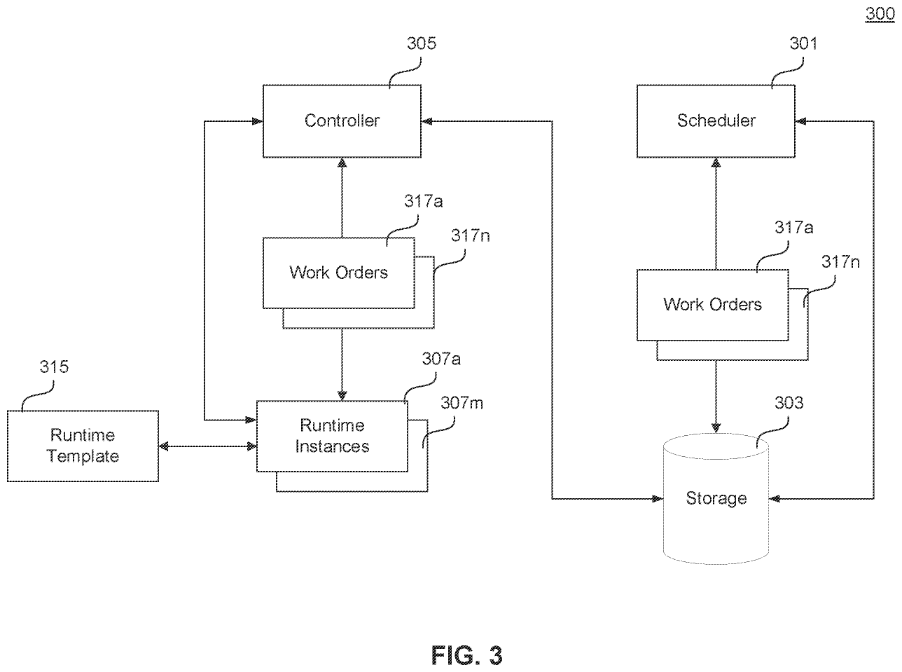

FIG. 3 is a block diagram of feedback loops in an exemplary E-T-L system 300, according to some embodiments. E-T-L system 300 can be, or can include, E-T-L system 120 of FIG. 1 and FIG. 2.

According to some embodiments, E-T-L system 300 can include two feedback loop—a scheduler loop and a controller loop. The scheduler loop can include scheduler 301 and storage 303. In the scheduler loop, scheduler 301 can determine (e.g., read) one or more E-T-L processes (e.g., E-T-L jobs) from storage 301. In some examples, the E-T-L processes can be defined externally to E-T-L system 300. In a non-limiting example, a user (e.g., a customer) can define the E-T-L processes. Additionally, or alternatively, scheduler 301 in the scheduler loop can generate one or more work orders, monitor the work orders, and generate additional work orders. In some examples, scheduler 301 can be (or can include) scheduler 201 of FIG. 2. Storage 303 can also be (or can include) storage 203 of FIG. 2.

The controller loop can include controller 305 and storage 303. Controller 305 can be (or can include) controller 205 of FIG. 2. Controller 305 can be configured to read (e.g., pull) the work orders from storage 303, create runtime instances, assign the work orders to the runtime instances, execute the work orders on the runtime instances, and update the work orders in storage 303.

E-T-L system 300 can include one or more runtime templates 315. In some examples, a runtime template can be used for a plurality of work order types. In these examples, the variances between the work order types can be included in the work orders, instead of having different runtime templates 315. For example work orders 317a-317n can have the same runtime template 315. Alternatively, one runtime template can be used for one or more work order types (Therefore, multiple runtime templates for multiple work order types). For example work orders 317a-317n can have multiple runtime templates 315.

In one example, the work order type can include a transfer type. In this example, runtime template 315 can be associated with the transfer type. In another example, the work order type can include a setup type, and runtime template 315 can be associated with the setup type. The setup work order can be used to setup the environment in the source and/or target systems. For example, the setup work order can be used to read the source object from the source system and use it to create the target object in the target system. In another example, the work order type can include a cleanup type, and runtime template 315 can be associated with the cleanup type. The cleanup work order can be used to cleanup the environment in the source and/or target systems. For example, the cleanup work order can be used to generate and cleanup stored procedures in either source or target systems. The embodiments of this disclosure are not limited to these examples and the work orders can include other types.

According to some embodiments, controller 305 can be configured to generate one or more runtime instances 307a-307m based on runtime template 315. Runtime instances 307a-307m can be (or can include) runtime instances 207a-207m of FIG. 2. Some examples of this disclosure discussed with respect to using one runtime template 315 to generate one or more runtime instances 307a-307m. However, as discussed above, more than one runtime template 315 can be used to generate runtime instances 307a-307m.

According to some embodiments, controller 305 can generate (or start or stop) runtime instance 307a based on work order 317a. Controller 305 can determine information associated with work order 317a (e.g., a work order type of work order 317a) to generate runtime instance 307a from runtime template 315. Runtime instance 307a can be a fully prepared environment with the components for executing work order 317a. In some examples, runtime instance 307a can be a single application or a set of micro-services that are loaded into a distributed cluster.

According to some embodiments a plurality of work orders 317a-317n and/or a plurality of runtime instances 307a-307m can be associated to one E-T-L process. Controller 305 can be configured to bundle work orders 317a-317n associated with the same E-T-L process, the same source system, and/or the same target system. In some examples, work orders 317a-317n associated with the same source system and/or the same target system can be associated to the same E-T-L process or to different T-E-L processes. Controller 305 can be configured to monitor, for example, the computational resources of E-T-L system 300. Based on the determined resources, controller 305 can be configured to bundle work orders 317a-317n. Additionally, or alternatively, based on the determined resources, controller 305 can be configured to generate (e.g., start) additional runtime instances 307. Controller 305 can also be configured to end (e.g., stop) runtime instance 307 if the execution of the associated work order 317 has ended.

According to some embodiments, scheduler 301 can be configured to determine an E-T-L process and generate one or more work orders 317a-317n based on the E-T-L process. For example, schedule 301 can be configured to break up the E-T-L process (e.g., an E-T-L job) into one or more work orders. In a non-limiting example, the E-T-L process can use a short amount of time to execute. For example, the E-T-L process can include an initial load process for loading a small source object from the source system to the target system. Such an E-T-L process can use small amount of time and computational resource to execute. Alternatively, the E-T-L process can use an indefinite amount of time and computation resources to execute. For example, a Delta Load for a source object with a very high change rate can use an indefinite amount of time and computation resources to execute.

According to some embodiments, scheduler 301 can be configured to generate one or more work orders 317a-317n based on the E-T-L process (e.g., the time and/or computational resources used for the E-T-L process) and based on the computational resources available to E-T-L system 300. In a non-limiting example, scheduler 301 can be configured to generate one or more work orders 317a-317n of the E-T-L process such that work orders 317a-317n can have equally sized work units. In some embodiments, the work units can be defined as the amount of time and/or computational resource for executing the work order. Scheduler 301 can be configured to generate one or more work orders 317a-317n of the E-T-L process using other methods and/or criteria. In some examples, E-T-L system 300 can be configured to execute multiple E-T-L processes in parallel. In a non-limiting example, E-T-L system 300 can be configured to execute multiple E-T-L processes in parallel for multiple users (e.g., customers) in a cloud service scenario.

According to some embodiments, scheduler 301 can be configured to store work orders 317a-317n in storage 303, Controller 305 can access work orders 317a-317n in storage 303.

According to some embodiments, scheduler 301 can generate a plurality of work orders 317a-317n for an E-T-L process. Scheduler 301 can further assign a sequence number to each of work orders 317a-317n. Additionally, or alternatively, scheduler 301 can assign a priority number to each of work orders 317a-317n. In some examples, the sequence number can indicate in which order work orders 317a-317n are generated and/or in which order work orders 317a-317n are to be executed. In some examples, the priority number can indicate the priority order for which work orders 317a-317n are to be executed.

According to some embodiments, scheduler 301 can also be configured to indicate a work order type for work orders 317a-317n. In some examples, work orders 317a-317n can include their corresponding work order type. According to some embodiments, scheduler 301 can also be configured to indicate whether a work order in work orders 317a-317n is configured to be executed alone or with the plurality of work orders. Work orders 317a-317n and their associated information (e.g., work order type, sequence number, priority number, etc.) are stored in storage 303.

As discussed above, each work order (e.g., work order 317a) can include a smallest work unit that can be tracked by E-T-L system 300, according to some embodiments. Work orders 317a-317n can include dynamic part of an E-T-L process and include the dynamic metadata used to move the E-T-L process forward by, for example, a predefined amount of time and/or computation resource. Assuming that work order 317a is executed on runtime instance 307a, during the execution of work order 317a on runtime instance 307a, work order 317a can be propagated with intermediate results between each of the steps. The final results are returned to controller 305. Controller 305 can update storage 303. During each step, controller 305 can update work order 317a (e.g., to fill in metrics and/or other information).

According to some embodiments, the contents of work orders 317a-317n can depend on the work order type. For example, a work order (e.g., work order 317a) can include metadata (e.g., dynamic metadata). The metadata can include one or more of work order type, identifier, source information, transformation information, target information, customer information, work order status, sequence number, priority number, concurrency information, and the like. However, the work order (e.g., work order 317a) can include other, more, or less information. In some examples, some of the metadata in the work order can be derived from previous work orders. According to some embodiments, scheduler 301 is configured to generate and/or assign the metadata to the work orders when schedule 301 generate the work orders.

As discussed above, the work order type can include, but is not limited to, transfer type, setup type, cleanup type, and the like. The identifier (II)) can include a unique identifier for a work order (e.g., work order 317a).

The source information can include a source type that indicates the type of the source system. The source information can also include connection information for connecting to the source system. The connection information can include, but is not limited to, information associated with a protocol, a hostname, a port, a username, a password, and the like. The source information can also include container information including information regarding a subsystem within the source system (e.g., a database schema). The source information can also include object information including an identifier for a source subject. The identifier for the source subject can include, but is not limited to the name of a table within a database, a topic within a message broker, and the like. The source information can also include schema information including a description of the schema of the source data including, for example, the names of the fields and their types in an appropriate format. The source information can also include range information including a description of the records that are to be extracted (e.g., a Structured Query Language (SQL) condition or other specification appropriate for the source system). The source information can also include one or more metrics such as, but not limited to, a number of records, a record size (e.g., in bytes), a processing time (e.g., in milliseconds), a memory usage (e.g., in MBs), and the like. The source information can include other, more, or less information.

The transformation information can include a transformation type indicating the type of the transformation. The transformation type can include, but is not limited to, “identity” (e.g., do nothing), “filter/projection,” “script,” “rules,”, and the like. The transformation information can also include filter description in an appropriate format (e.g., SQL, JavaScript Object Notation (JSON) encoded, and the like). The transformation information can also include projection description in an appropriate format (e.g., a list of output fields in an order, with an optional mapping from input field name to output field name, and the like). The transformation information can also include user-defined script to transform the data in an appropriate format (e.g., a Python sandbox script, and the like). The transformation information can include other, more, or less information.

The target information have information similar to the source information but specific for the target system. The concurrency information can include information indicating whether two or more work orders are to be executed in parallel.

As discussed above, controller 305 is configured to read work orders 317a-317n from storage 303, generate runtime instances 307a-307m, assign work orders 317a-317n to runtime instances 307a-307m, execute work orders 317a-317n on runtime instances 307a-307m, and update work orders 317a-317n. For example, controller 305 can read work order 317a from storage 303 and generate runtime instance 307a from runtime template 315. Additionally, or alternatively, controller 305 has generated runtime instance 307a from runtime template 315 before reading work order 317a.

Controller 305 can be configured to assign work order 317a to runtime instance 307a. In some embodiments, controller 305 can be configured to assign work order 317a to runtime instance 307a based on the metadata of work order 317a and/or one or more parameters of E-T-L system 300 (e.g., available computation resources, performance, etc.) According to some embodiments, and to optimize cache usage and reduce overhead, controller 305 can be configured to assign work orders 317a-317n in batches to runtime instances 307a-307m. In these examples, controller 305 can avoid context switching by executing several work orders for the same E-T-L process, for the same source system, and/or for the same target system consecutively.

After assigning work order 317a to runtime instance 307a, controller 305 can execute work order 317a on runtime instance 307a. Controller 305 can also be configured to monitor and track the execution of work order 317a on runtime instance 307a. Controller 305 can update work order 317a in, for example, storage 303, based on the execution of work order 317a on runtime instance 307a, Additionally, or alternatively, controller 305 can store information associated with the execution of work order 307a in, for example, storage 303. For example, to monitor and track the execution of work order 317a on runtime instance 307a, controller 305 can determine whether the execution of the work order was successful or failed. Controller 305 can add this information in storage 303 separately and/or by updating metadata of work order 317a.

In some embodiments, scheduler 301 can use the execution information and/or the updated metadata of work order 317a to determine whether work order 317a land/or its associated E-T-L process) is to be suspended and/or rescheduled. For example, if the execution information and/or the updated metadata of work order 317a indicates an execution failure (e.g., a connection failure for a source/target system, and the like), scheduler 31 can suspend work order 317a (and/or its associated E-T-L processes). Alternatively, scheduler 31 can reschedule work order 317a (and/or its associated E-T-L processes) for a predetermined time.

According to some embodiments, to monitor and track the execution of work order 317a on runtime instance 307a, controller 305 can collect information associated with the execution. The information can include, but is not limited to a number of records that were transferred using work order 317a, a runtime usage of work order 317a, a computational resource usage during the execution of work order 317a, and the like. This information can be used (by controller 305 and/or scheduler 301) to identify bottlenecks, for pay-as-you-go plans (according to actual usage), for automatic problem reporting, and the like.

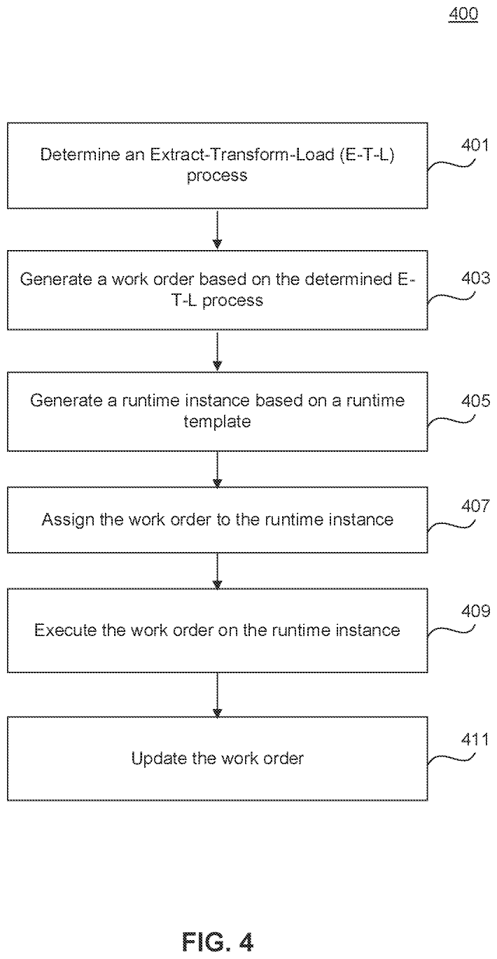

FIG. 4 is a flowchart illustrating example operations of an E-T-L system, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art. Method 400 shall be described with reference to FIGS. 1-3. However, method 400 is not limited to the example embodiments.

In 401, an E-T-L process is determined. For example, an E-T-L system (e.g., system 102 of FIGS. 1 and 2 or E-T-L system 300 of FIG. 3 determines an E-T-L process to be executed. In some embodiments, the E-T-L process can be stored in a storage (e.g., storage 203 of 303) and an scheduler (e.g., scheduler 201 or 301) can determine the E-T-L process to be executed. The E-T-L process can be generated or requested by a user (e.g., a customer) of the E-T-L system. Although some examples are discussed with respect to an E-T-L process, the embodiments of this disclosure can include other processes.

In 403, one or more work orders are generated based on the determined E-T-L process. For example, the E-T-L system (or the scheduler of the E-T-L system) can generate the one or more work orders. 1n some embodiments, the scheduler can be configured to generate one or more work orders (e.g., work orders 317a-317n) of the E-T-L process such that the work orders can have equally sized work units. In some embodiments, the work units can be defined as the amount of time and/or computational resource for executing the work order.

Operation 403 can further include assigning one or more parameters (e.g., metadata such as dynamic metadata) to each one of the work orders. For example, the scheduler can assign the metadata to each work order. As discussed above, the metadata can include, but is not limited to, one or more of work order type, identifier, source information, transformation information, target information, customer information, work order status, sequence number, priority number, concurrency information, and the like.

Operation 403 can further include storing the one or more work orders in the storage. For example, the scheduler can store the generated work orders with their associated metadata in the storage (e.g., storage 203 or 303).

In some embodiments, operation 403 can also include determining (e.g., by the scheduler) a plurality of work orders for the E-T-L process. Further, assigning the metadata to each one of the work orders can include assigning (e.g., by the scheduler) a sequence number to each of the plurality of work orders and assigning (e.g., by the scheduler) a priority number to each of the plurality of work orders. Assigning the metadata to each one of the work orders can also include indicating (e.g., by the scheduler) a work order type to each of the plurality of work orders and indicating (e.g., by the scheduler) whether the plurality of work orders to be executed concurrently (or substantially concurrently).

In 405, one or more runtime instances are generated based on one or more runtime templates. For example, a controller (e.g., controller 205 or 305) of the E-T-L system generates one or more runtime instances (e.g., runtime instances 207 or 307) based on one or more runtime templates (e.g., runtime template 315). According to some embodiments, each runtime instance can be a fully prepared environment with the components for executing the generated work order. In some examples, the runtime instance can be a single application or a set of micro-services that are loaded into a distributed cluster.

According to some embodiments, generating the runtime instance can include starting an already generated runtime instance from the runtime template. In some examples, generating (or starting or stopping) the runtime instance can be based on the work order generated in operation 403. In these examples, operation 403 can include reading (e.g., by the controller) the generated work order from the storage and generating the runtime instance based on metadata of the generated work order.

In some embodiments, operation 405 can further include determining (e.g., by the controller) a number of work orders that are to be executed by the E-T-L system. For example, the controller can read the work orders that are generated in operation 403 and determine the number of the work orders. Depending on the number of the work orders (and/or other parameters of the E-T-L system), the controller can generate (e.g., start) or stop additional runtime instances. In some examples, the other parameters of the E-T-L system can include computation resource usage/availability, performance parameters, and the like of the E-T-L system. According to some embodiments, if the number of work orders satisfies a first condition (e.g., more than a first threshold value), then the controller can generate (e.g., start) additional runtime instances from the runtime template. If the number of work orders satisfies a second condition (e.g., less than a second threshold value), then the controller can stop one or more runtime instances from the runtime template. In some examples, the first and second threshold values can be the same value.

In some embodiments, operation 405 can further include determining (e.g., by the controller) a latency parameter to be achieved by the E-T-L system. In some examples, the latency parameter can be set by a user (e.g., a customer) of the E-T-L system. Depending on the latency parameter (number of work orders, backlog (e.g., the unfulfilled work orders), and/or other parameters of the E-T-L system), the controller can generate (e.g., start) or stop additional runtime instances. According to some embodiments, if the latency parameter satisfies a first condition (e.g., a latency requirement of the user is less than a first threshold value), then the controller can generate (e.g., start) additional runtime instances from the runtime template. If the latency parameter satisfies a second condition (e.g., the latency requirement of the user is more than a second threshold value), then the controller can stop one or more runtime instances from the runtime template. In some examples, the first and second threshold values can be the same value.

In some embodiments, operation 405 can also combine a plurality of work orders. For example, the controller of the E-T-L system can read the plurality of work orders that are generated in operation 403 and can combine the plurality of work orders into a combined work order. In some examples, the controller can combine the plurality of work orders associated with the same E-T-L process to generate the combined work order. Additionally, or alternatively, the controller can combine the plurality of work orders associated with the same source system (e.g., multiple tables in the same source system are in the Delta Load phase) to generate the combined work order. Additionally, or alternatively, the controller can combine the plurality of work orders associated with the same target system to generate the combined work order. In some embodiments, combining the work orders can also be based on computation resource availability and/or performance parameters of the E-T-L system.

In 407, the generated work order is assigned to the generate runtime instance. For example, the E-T-L system (e.g., using the controller) assigns the work order to the runtime instance. In some examples, the E-T-L system (e.g., using the controller) is configured to assign the work order to the runtime instance based on the metadata of the work order that was set by, for example, the scheduler.

In 409, the work order is executed on the runtime instances. For example, the controller of the E-T-L process executes the work order on the runtime instance. In some examples, the executing the work order includes executing a portion of the E-T-L process from which the work order was generated.

In 411, the work order is updated based on its execution. For example, the controller of the E-T-L process monitors and tracks the execution of the work order and can update the metadata of the work order based on the execution of the work order. In 411, the controller can store information associated with the execution of the work order in the storage. The information can be stored separate from (but associated with) the work order. Additionally, or alternatively, the information can be stored as the update(s) to the metadata of the work order. In some examples, monitoring and tracking the work order can include determining (e.g., by the controller) whether the execution of the work order was successful or failed. In these examples, the information associated with the execution of the work order can include a number of records that were transferred using the work order, a runtime usage of the work order, or a resource usage during the execution of the work order.

In some embodiments, method 400 can further include suspending (e.g., by the scheduler) the E-T-L process in response to the information indicating that the execution of the work order failed. Additionally, or alternatively, method 400 can include rescheduling (e.g., by the scheduler) the E-T-L process in response to the information indicating that the execution of the work order failed.

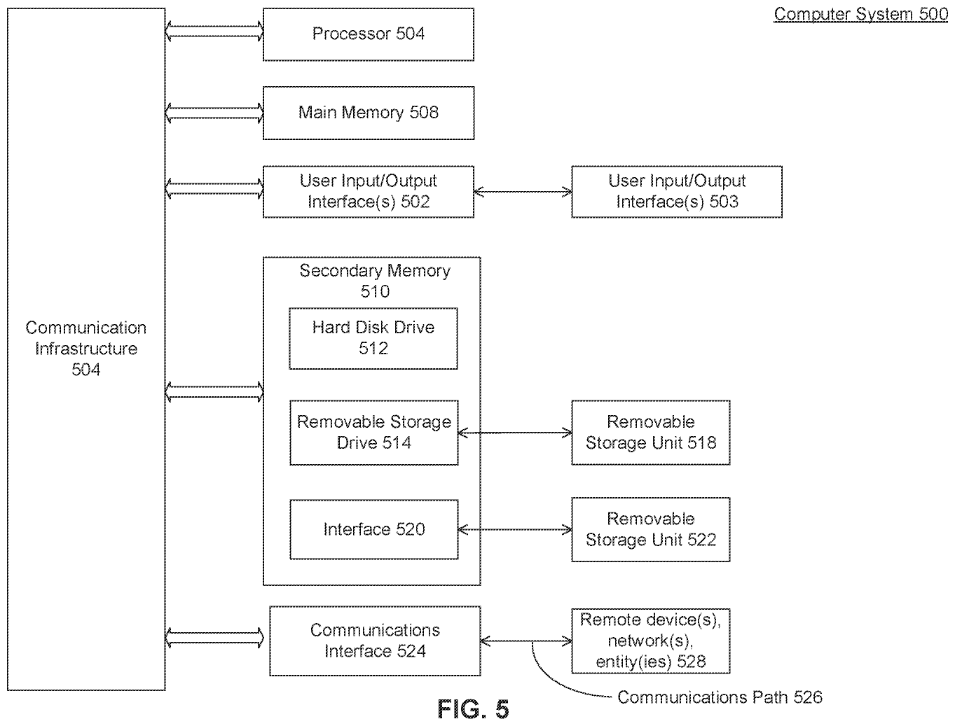

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a. Communication infrastructure or bus 506.

Computer system 500 may also include customer input/output device(s) 503, such as monitors, keyboards, pointing devices, etc., which may communicate with communication infrastructure 506 through customer input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518.

Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500, Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524, Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g.; content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON). Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes; but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method comprising:
generating, by a controller, a runtime instance based on a runtime template;
assigning, by the controller, a work order to the runtime instance, wherein the work order is generated based on an Extract-Transform-Load (E-T-L) process;
executing, by the controller, the work order on the runtime instance; and
updating, by the controller, the work order in a storage.

2. The method of claim 1, wherein the assigning the work order to the runtime instance comprises assigning, by the controller, the work order to the runtime instance based on metadata of the work order.

3. The method of claim 1, further comprising:
tracking, by the controller, the execution of the work order on the runtime instance; and
storing, by the controller, information associated with the execution of the work order in the storage.

4. The method of claim 3, wherein the tracking comprises determining whether the execution of the work order was successful or failed.

5. The method of claim 4, wherein the information associated with the execution of the work order comprises a number of records that were transferred using the work order, a runtime usage of the work order, or a resource usage during the execution of the work order.

6. The method of claim 1, further comprising:
determining a number of work orders to be executed by the controller;
in response to the number of work orders satisfying a first condition, generating one or more additional runtime instances to execute the work orders; and
in response to the number of work orders satisfying a second condition, stopping the one or more additional runtime instances.

7. The method of claim 1, further comprising:
combining, by the controller, a plurality of work orders associated with the E-T-L process, associated with a source system, or associated with a source system into a combined work order.

8. A system comprising:
a memory; and
at least one processor coupled to the memory and configured to:
determine an Extract-Transform-Load (E-T-L) process;
generate a work order based on the determined E-T-L process;
generate a runtime instance based on a runtime template;
assign, based on metadata of the work order, the work order to the runtime instance;
execute the work order on the runtime instance; and
update the work order in the memory.

9. The system of claim 8, wherein the processor is further configured to:
track the execution of the work order on the runtime instance; and
store information associated with the execution of the work order in the memory,
wherein the information associated with the execution of the work order comprises a number of records that were transferred using the work order, a runtime usage of the work order, or a resource usage during the execution of the work order.

10. The system of claim 9, wherein to track the execution of the work order, the processor is configured to determine whether the execution of the work order was successful or failed.

11. The system of claim 10, wherein the processor is further configured to:
suspend the E-T-L process in response to the information indicating that the execution of the work order failed, or
reschedule the E-T-L process in response to the information indicating that the execution of the work order failed.

12. The system of claim 8, wherein the processor is further configured to:
determine a plurality of work orders for the E-T-L process;
assign a sequence number to each of the plurality of work orders;
assign a priority number to each of the plurality of work orders;
indicate a work order type to each of the plurality of work orders; and
indicate whether the work order is configured to be executed with the plurality of work orders.

13. The system of claim 8, wherein the processor is further configured to:
determine a number of work orders to be executed;
in response to the number of work orders satisfying a first condition, generate one or more additional runtime instances to execute the work orders; and
in response to the number of work orders satisfying a second condition, stop the one or more additional runtime instances.

14. The system of claim 8, wherein the processor is further configured to:
combine a plurality of work orders associated with the E-T-L process, associated with a source system, or associated with a source system into a combined work order.

15. The system of claim 8, wherein the runtime instance comprises a single application or a plurality of micro-services loaded into a distributed cluster.

16. A non-transitory computer-readable device having instructions stored thereon that, when executed by at least one computing device, cause the at least one computing device to perform operations comprising:
generating a runtime instance based on a runtime template;
assigning a work order to the runtime instance based on metadata of the work order, wherein the work order is generated based on an Extract-Transform-Load (E-T-L) process;
executing the work order on the runtime instance; and
updating the work order in a storage.

17. The computer-readable device of claim 16, wherein the operations further comprise:
tracking the execution of the work order on the runtime instance; and
storing information associated with the execution of the work order in the storage, wherein the information associated with the execution of the work order comprises a number of records that were transferred using the work order, a runtime usage of the work order, or a resource usage during the execution of the work order.

18. The computer-readable device of claim 17, wherein the tracking comprises determining whether the execution of the work order was successful or failed and the operations further comprise:
suspending the E-T-L process in response to the information indicating that the execution of the work order failed, or
rescheduling the E-T-L process in response to the information indicating that the execution of the work order failed.

19. The computer-readable device of claim 16, wherein the operations further comprise:
determining a number of work orders to be executed;
in response to the number of work orders satisfying a first condition, generating one or more additional runtime instances to execute the work orders; and
in response to the number of work orders satisfying a second condition, stopping the one or more additional runtime instances.

20. The computer-readable device of claim 16, wherein the operations further comprise:
combining a plurality of work orders associated with the E-T-L process, associated with a source system, or associated with a source system into a combined work order.
